(19) United States
(12) Patent Application Publication
(10) Pub. No.: US 2004/0218594 A1
(43) Pub. Date: Nov. 4, 2004

(54) System and method for responding to multiple messages

(76) Inventor: Christopher M. Wolfe, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 10/427,199

(22) Filed: May 1, 2003

(51) Int. Cl. H04L 12/28

(52) U.S. Cl. 370/389

(57) ABSTRACT

There is shown and described a messaging device (102), and a method thereof, for responding to multiple messages. A user interface (208) detects (406, 506) selection of existing messages from a message receptacle and identifies (414, 508) an outgoing message. A processor (202) then populates (416, 510) an outgoing header field of the outgoing message with information from existing header fields of the existing messages in response to identifying (414, 508) the outgoing message or detecting selection of an existing message. The processor (202) may also populate (420, 514) the outgoing header field of the outgoing message in response to detecting (418, 512) selection of additional messages. A transceiver (206) then sends (428, 522) the outgoing message to a destination device corresponding to the information populated in the outgoing header field.

### FIELD OF THE INVENTION

The present invention relates generally to the field of messaging systems for communication devices. In particular, the present invention relates to messaging devices for managing destination addresses, or identities associated with destination addresses, for messages.

### BACKGROUND OF THE INVENTION

Messaging systems are commonly used for communication text messages and attachments between messaging devices. For each new message created by a messaging device, a user provides one or more destination addresses at a header portion of the new message so that the messaging system will know the recipient(s) of the new message. To facilitate entry of destination addresses into the header portion, the user may open an address book and select destination addresses for placement in the header portion.

Of particular convenience is a Reply feature of many email applications. If a user selects a single incoming message and activates a Reply feature, the email application will create a new message and place the sender's destination in the recipient field of the new message. Unfortunately, the Reply feature may only be applied to a single selected message and does not work for a selection of multiple messages. Accordingly, there is a need for a messaging system, device and method that conveniently retrieve destination addresses from multiple messages for use by an outgoing message.

### BRIEF DESCRIPTION OF THE DRAWINGS

FIG. 1 is a perspective view of an exemplary system embodiment in accordance with the present invention.

FIG. 2 is a block diagram of an exemplary messaging device of FIG. 1.

FIG. 3 is a screen view of an exemplary messaging device of FIG. 1.

FIG. 4 is a flow diagram of an operation of a first preferred embodiment of a messaging device of FIG. 1.

FIG. 5 is a flow diagram of an operation of a second preferred embodiment of a messaging device of FIG. 1.

### DETAILED DESCRIPTION OF THE PREFERRED EMBODIMENTS

One aspect of the present invention is a messaging device, and a method thereof, for responding to multiple messages comprising a user interface, a processor and a transceiver. The user interface is configured to identify a first message and to detect selection of a second message from a message receptacle. Preferably, the first message is identified as a new message or an existing message. The first and second messages include first and second header fields, respectively. The processor is configured to populate the first header field of the first message with information from the second header field of the second message in response to detecting selection of the second message by the user interface. The transceiver is configured to send the second message to a destination device corresponding to the information populated in the second header field.

For the method of this first aspect, selection of a plurality of existing messages from a message receptacle is detected. An outgoing message is then identified. Next, the outgoing header field of the outgoing message is populated with information from the existing header fields of the plurality of existing messages in response to identifying the outgoing message. Thereafter, the outgoing message is sent to a destination device corresponding to the information populated in the outgoing header field.

Another aspect of the present invention is a messaging device, and a method thereof, for responding to multiple messages comprising a user interface, a processor and a transceiver. The user interface is configured to detect selection of a plurality of existing messages from a message receptacle and to identify an outgoing message. Preferably, the outgoing message is identified as either a new message or an existing message. Each existing message of the plurality of existing messages includes an existing header field, and the outgoing message includes an outgoing header field. The processor is configured to populate the outgoing header field of the outgoing message with information from the existing header fields of the plurality of existing messages in response to identifying the outgoing message by the user interface. The transceiver is configured to send the outgoing message to a destination device corresponding to the information populated in the outgoing header field.

For the method of this second aspect, a first message is identified. Selection of a second message from a message receptacle is then detected. Next, the first header field of the first message is populated with information from the second header field of the second message in response to detecting selection of the second message. Thereafter, the second message is sent to a destination device corresponding to the information populated in the second header field.

Although the embodiments disclosed herein are particularly well suited for use with a cellular telephone, persons of ordinary skill in the art will readily appreciate that the teachings of this disclosure are in no way limited to cellular telephones. On the contrary, persons of ordinary skill in the art will readily appreciate that the teachings of this disclosure can be employed with any type of wired or wireless messaging device such as a personal computer (such as a desktop, laptop, notebook, sub-notebook or tablet computer), a terminal for a multi-user computing system, a radiotelephone, a paging device, a personal digital assistant (“PDA”), a hybrid device that includes messaging capabilities, and the like.

The messaging system in accordance with the present invention is described in terms of several preferred embodiments, and particularly, in terms of a messaging system operating in accordance with at least one of several standards. These standards apply to wired messaging systems such as, but not limited to, local area networks, wide area networks, Ethernets, intranets, internets (including “the Internet”) and a combination of these systems. These standards also include analog, digital or dual-mode wireless communication system protocols such as, but not limited to, the Advanced Mobile Phone System (“AMPS”), the Narrowband Advanced Mobile Phone System (“NAMPS”), the Global System for Mobile Communications (“GSM”), the IS-55 Time Division Multiple Access (“TDMA”) digital cellular system, the IS-95 Code Division Multiple Access (“CDMA”) digital cellular system, CDMA 2000, the Personal Communications System (“PCS”), 3G, the Universal Mobile Telecommunications System (“UMTS”), and variations and evolutions of these protocols. The messaging system in accordance with the present invention may also operate via an ad hoc network and, thus, provide point-to-point messaging with the need for intervening infrastructure. Examples of the messaging protocols used by the ad hoc networks include, but are not limited to, IEEE 802.11a, IEEE 802.11b, IEEE 802.11g, Bluetooth, and infrared technologies.

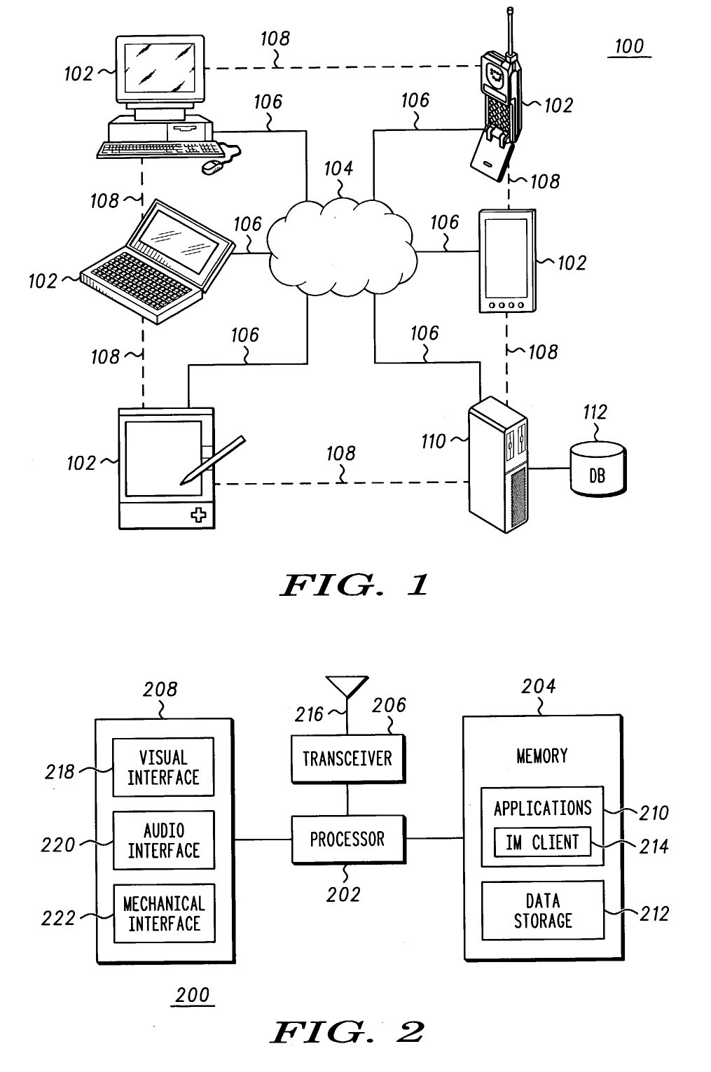

Referring to FIG. 1, there is shown a messaging system 100 in accordance with the present invention. The messaging system 100 includes a plurality of messaging devices 102 communicating with each other. For one embodiment of the system 100, the plurality of messaging devices 102 may communicate through a messaging network 104 via network connections 106 as shown in FIG. 1. For another embodiment of the system 100, the plurality of messaging devices 102 may communicate with each other directly via direct links 108, i.e., a point-to-point or ad hoc network.

FIG. 2 shows various exemplary components that may be utilized by each messaging device 102 of the messaging system 100. Each messaging device 102 may include a processor 202 and a memory 204, at least one transceiver 206 and a user interface 208 that are coupled together for operation of the respective messaging device. It is to be understood that two or more of these internal components 200 may be integrated within a single package, or functions of each internal component may be distributed among multiple packages, without adversely affecting the operation of each messaging device 102.

As stated above, each messaging device 102 includes the processor 202 and the memory 204. The processor 202 controls the general operation of the messaging device 102 including, but not limited to, processing and generating data for each of the other internal components 200. The memory 204 may include an applications portion 210, and/or a data storage portion 210. The applications portion 210 includes operating instructions for the processor 202 to perform various functions of the messaging device 102. A program of the set of the operating instructions may be embodied in a computer-readable medium such as, but not limited to, paper, a programmable gate array, flash memory, application specific integrated circuit (“ASIC”), erasable programmable read only memory (“EPROM”), read only memory (“ROM”), random access memory (“RAM”), magnetic media, and optical media. The data storage portion 212 stores data that is utilized by the applications stored in the applications portion 210. For the preferred embodiment, the applications portion 210 is non-volatile memory that includes a client or messaging application 214 for communicating with a main application operated at a remote device, and the data storage portion 212 is also non-volatile memory that stores data in a data storage that is utilized by the client application and associated with the messaging device 102 or user of the messaging device. In the alternative, a messaging system, or a portion thereof, may be stored in the memory 204 of a particular messaging device 102.

Each messaging device 102 also includes at least one transceiver 206. The transceiver 206 provides messaging capabilities with other entities, such as the messaging network 104 and/or other messaging devices 102. For the preferred embodiment, the transceiver 206 operates through an antenna 216 in accordance with at least one of several standards including analog, digital or dual-mode messaging system protocols and, thus, communicates with appropriate infrastructure. However, as referenced above, the transceiver 206 may also, or instead, provide point-to-point messaging via an ad hoc network.

Each messaging device 102 also includes the user interface 208. The user interface 208 may include a visual interface 218, an audio interface 220 and/or a mechanical interface 222. Examples of the visual interface 218 include displays and cameras, examples of the audio interface 220 include speakers and microphones, and examples of the mechanical interface 222 includes keypads, touch pads, touch screens, selection buttons, vibrating mechanisms, and contact sensors. For example, a user may utilized the user interface 208 to provide input to be shown on a display and make selections for the display by using mechanical instructions, e.g., touching a touch pad overlapping the display, keypad keys or selection buttons, or providing audible commands and data into a microphone. For all preferred embodiments of the present invention, each messaging device 102 includes a display to provide output information associated with the messaging system to corresponding users. On the other hand, alternative embodiments may include other types of output devices, audio or mechanical, to provide output to users.

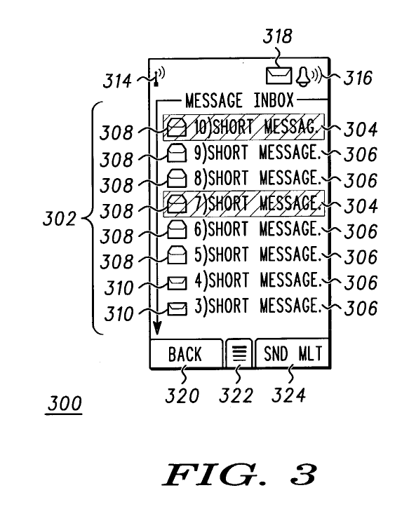

Referring to FIG. 3, there is provided a screen view 300 of a visual interface 218 of an exemplary messaging device 102. The screen view 300 includes a message receptacle 302 and a plurality of messages. As shown in FIG. 3, the message receptacle may be a Message Inbox for receiving incoming messages, but it is to be understood that the message receptacle may also be a Message Outbox for sending outgoing messages. If the message receptacle is the Message Inbox, then source address, i.e., an address of the sending party, is extracted from each incoming message. If the message receptacle is the Message Outbox, then the destination address or addresses, i.e., an address or addresses of the receiving party or parties, is extracted from each outgoing message. For the preferred embodiments, the selected messages 304 are distinguished visually from the non-selected messages 306. Messages may be selected using the user interface 208, such as the visual interface 218, audio interface 220 and/or mechanical interface 222, as described above.

The screen view 300 may also include other information that may be useful to a user. As shown in FIG. 3, the screen view 300 may include viewed message indicator 308 and non-viewed message indicator 310 to distinguish messages that have already been viewed by the user from message that have not yet been viewed by the user, respectively. The screen view 300 may also include an extension indicator 312 to provide the user an indication that additional messages, not currently shown on the visual interface 218, are available for viewing by the user. In addition, the screen view 300 may include indicators for the status of the messaging device 102 and/or the messaging application 214. For example, a signal strength indicator 314 and an audio type indicator 316 relating to the status of the messaging device 102 and a new message indicator 318 relating to the status of the messaging application 214 may be provided at the top of the screen view 300.

The screen view 300 may further includes function indicators 320, 322, 324 representing various functions that may be activated by the user. For example, as shown in FIG. 3, three function indicators 320, 322, 324 are provided at the bottom of the screen view 300 and correspond to three function keys (not shown) of the mechanical interface 222. Examples of function indicators include, but are not limited to, a BACK function indicator 314 representing the user's ability to activate a return to a previous screen or action of the current application, a selection function indicator 316 representing the user's ability to select a particular message (e.g., one at a time) of the message receptacle 302, and a SND MLT function indicator 318 representing the user's ability to send multiple a message to multiple destinations. For the preferred embodiments, the user may select a function key corresponding to the SND MLT function 318 indicator or an area of a touch screen area overlaying the SND MLT function indicator to either generating a new message or otherwise identifying a message, such as an existing message, for receiving destination information from selected messages 304.

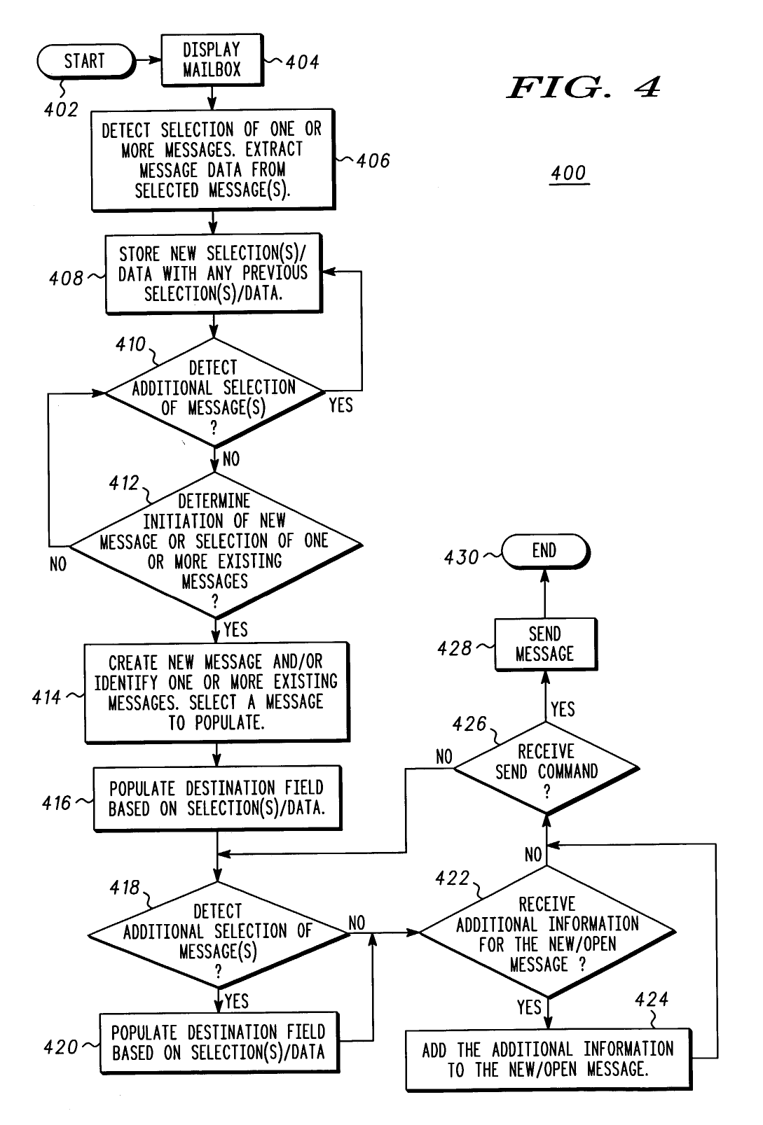

Referring to FIG. 4, there is provided a flow diagram of an operation 400 of a first preferred embodiment of a messaging device 102. Beginning at step 402, the messaging application 214 may display a messaging receptacle or mailbox at step 404. The mailbox may include one or both of an Inbox or incoming message area and an Outbox or outgoing message area. The Outbox may include separate areas for messages waiting to be sent and messages already sent. Next, at step 406, the messaging application 214 may detect selection of one or more messages within the messaging receptacle. The selected messages may be in the Inbox, the Outbox or both. Also, in step 406, the messaging application 214 may optionally extract message data from the selected messages. Preferably, the message data is a source address found in a header of an incoming message of the Inbox and/or a destination address found in a header of an outgoing message of the Outbox. The messaging application 214 may then store the new selection or selections and/or message data in the memory 204 at step 408.

After detecting and storing new selection(s) and/or message data, the messaging application 214 may detect selection of an additional message or additional messages by the user interface 208 at step 410 and determine whether a new message has been initiated or at least one existing message has been selected by the user interface 208 at step 412. Each time the messaging application 214 detects a selection of one or more additional messages at step 410, the messaging application stores these additional selections and/or corresponding message data with the previously stored selection(s) and/or message data at step 408. This process continues until the messaging application 214 identifies a future outgoing message by determining that a new message or at least one existing message has been activated via the user interface 208 at step 412. In response to identifying the future outgoing message, the messaging application 214 creates a new message and/or selects one or more existing messages, whatever is selected via the user interface 208, at step 414.

After a new message is created and/or one or more existing messages are selected, the messaging application 214 may have identified more than one message that may be sent in the future. Thus, the messaging application 214 may need to determine which message includes destination fields that should be populated at step 414. If only a new message is created or if only one existing message is selected, then decision is clear or no decision needs to be made. For the preferred embodiments, if messaging application 214 must choose the message to be populated, then the new message is selected by default; if a new message does not exist, then the messaging application chooses the most recently selected message. For such case, this selected message becomes the future outgoing message.

Thereafter, at step 416, the messaging application 214 may populate a destination field of the future outgoing message, specifically the destination field of the message's header, with the selection(s) and/or message data stored in the memory 204. The messaging application 214 automatically, in response to identifying the future outgoing message, populates the destination field of the future outgoing message. The destination field may include destination addresses to which the future outgoing message is directed. For the preferred embodiments, these destination addresses are based on the source addresses of incoming messages selected in the Inbox and/or destination addresses of outgoing messages selected in the Outbox. Preferably, the source addresses are associated with a “from:” designation of one or more messages, and the destination addresses are associated with a “to:” designation of one or more messages. In should be noted that destination addresses of outgoing message may include those addresses included in carbon copy or blind carbon copy fields, i.e., “cc:” or “bcc:”, of outgoing messages.

The messaging application 214 may determine whether additional messages have been selected, additional information has been received and/or the future outgoing message is ready to be sent. In particular, at step 418, the messaging application 214 may detect whether additional messages have been selected by the user interface 208. If so, the messaging application 214 populates the destination field of the future outgoing message based on the additional messages or message data corresponding to the additional messages at step 420. The messaging application 214 automatically populates the destination field of the future outgoing message in response to detecting selection of an addition message or additional messages. The additional messages or message data may be appended to the information already populated in the destination field at step 416.

The messaging application 214 may also receive additional information for the future outgoing message at step 422. Such additional information may populate, but is not limited to populating, a carbon copy field, a blind carbon copy field, an attachment receiving part of the message, and text and/or images for the body of the message. If additional information is received, then the messaging application 214 adds the additional information to the future outgoing message at step 424. The messaging application 214 may continue to check for additional selected messages and additional information for the future outgoing message until a send command is received by the user interface 208 at step 426. If the send command is received, then the future outgoing message is sent at step 428 by the transceiver 206 and the operation ends at step 430.

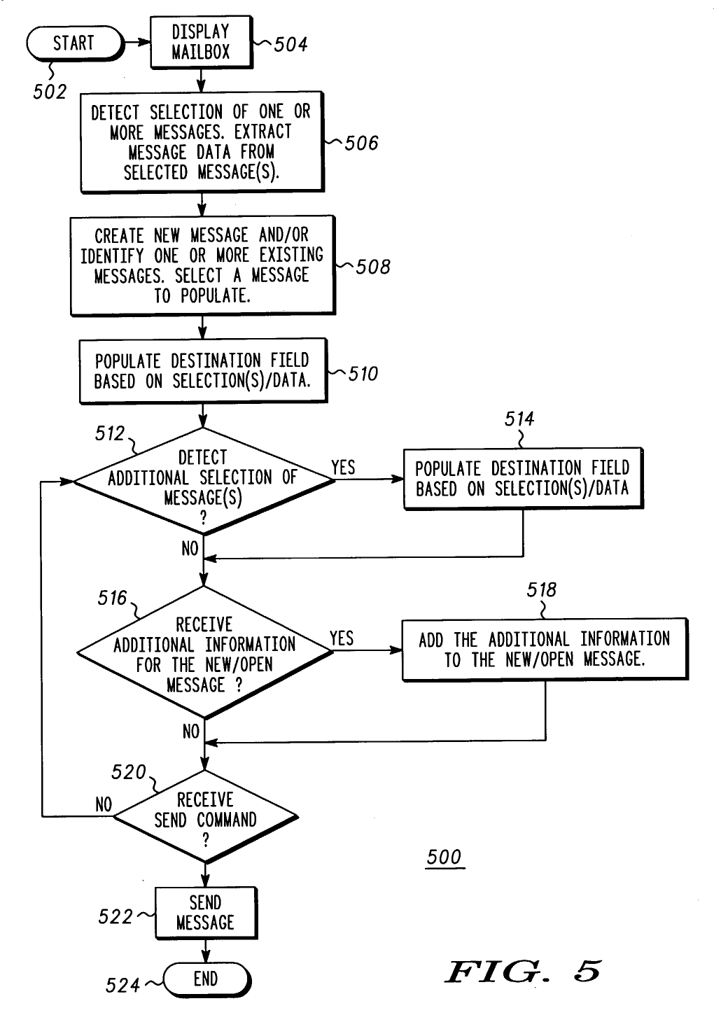

Referring to FIG. 5, there is provided a flow diagram of an operation 500 of a second preferred embodiment of a messaging device 102. The operation 500 of the second preferred embodiment is similar to the operation 400 of the first preferred embodiment described above. Beginning at step 502, the messaging application 214 may display a messaging receptacle or mailbox at step 504. Next, at step 506, the messaging application 214 may detect selection of one or more messages within the messaging receptacle. Also, in step 506, the messaging application 214 may optionally extract message data from the selected messages.

The messaging application 214 then identifies a future outgoing message at step 508. In particular, the messaging application 214 creates a new message or selects at least one existing message via the user interface 208 at step 508. In response to identifying the future outgoing message, the messaging application creates a new message and/or selects one or more existing messages, whatever is selected via the user interface 208, at step 508. After a new message is created and/or one or more existing messages are selected, the messaging application 214 may have identified more than one message that may be sent in the future. Thus, the messaging application 214 may need to determine which message includes destination fields that should be populated at step 508. For such case, this selected message becomes the future outgoing message.

Thereafter, at step 510, the messaging application 214 may populate a destination field of the future outgoing message, specifically the destination field of the message's header, with the selection(s) and/or message data stored in the memory 204. The messaging application 214 automatically, in response to identifying the future outgoing message, populates the destination field of the future outgoing message.

The messaging application 214 may determine whether additional messages have been selected, additional information has been received and/or the future outgoing message is ready to be sent. In particular, at step 512, the messaging application 214 may detect whether additional messages have been selected by the user interface 208. If so, the messaging application 214 populates the destination field of the future outgoing message based on the additional messages or message data corresponding to the additional messages at step 514. The messaging application 214 automatically populates the destination field of the future outgoing message in response to detecting selection of an addition message or additional messages. The additional messages or message data may be appended to the information already populated in the destination field at step 510.

The messaging application 214 may also receive additional information for the future outgoing message at step 516. If additional information is received, then the messaging application 214 adds the additional information to the future outgoing message at step 518. The messaging application 214 may continue to check for additional selected messages and additional information for the future outgoing message until a send command is received by the user interface 208 at step 520. If the send command is received, then the future outgoing message is sent at step 522 by the transceiver 206 and the operation ends at step 524.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of a messaging device for responding to multiple messages comprising:
detecting selection of a plurality of existing messages, each existing message including an existing header field, from a message receptacle;
identifying an outgoing message including an outgoing header field;
populating the outgoing header field of the outgoing message with information from the existing header fields of the plurality of existing messages in response to identifying the outgoing message; and
sending the outgoing message to a destination device corresponding to the information populated in the outgoing header field.

2. The method of claim 1, wherein detecting selection of a plurality of existing messages, each existing message including an existing header field, from a message receptacle comprises:
determining that the existing header field is at least one of a source field and a destination field.

3. The method of claim 1, wherein detecting selection of a plurality of existing messages, each existing message including an existing header field, from a message receptacle comprises:
storing the information from the first header fields of the plurality of first messages as the plurality of first messages are selected.

4. The method of claim 3, wherein populating the outgoing header field of the outgoing message with information from the existing header fields of the plurality of existing messages in response to identifying the outgoing message comprises:
providing the stored information to the outgoing header field of the outgoing message.

5. The method of claim 1, wherein identifying an outgoing message including an outgoing header field comprises:
identifying one of generating a new message and identifying another existing message.

6. A method of a messaging device for responding to multiple messages comprising:
identifying a first message including a first header field;
detecting selection of a second message, including a second header field, from a message receptacle;
populating the first header field of the first message with information from the second header field of the second message in response to detecting selection of the second message; and
sending the second message to a destination device corresponding to the information populated in the second header field.

7. The method of claim 6, wherein identifying an outgoing message including an outgoing header field comprises:
identifying one of generating a new message and identifying an existing message.

8. The method of claim 6, wherein detecting selection of a second message, including a second header field, from a message receptacle comprises:
determining that the second header field is at least one of a source field and a destination field.

9. The method of claim 6, further comprising:
detecting selection of a third message, including a third header field, from a message receptacle after populating the first header field of the first message with the information from the second header field of the second message.

10. The method of claim 9, further comprising:
appending the information in the first header field of the first message with information from the third header field of the third message in response to detecting selection of the third message.

11. A messaging device for responding to multiple messages comprising:
a user interface configured to detect selection of a plurality of existing messages, each existing message including an existing header field, from a message receptacle, and to identify an outgoing message including an outgoing header field;
a processor configured to populate the outgoing header field of the outgoing message with information from the existing header fields of the plurality of existing messages in response to identifying the outgoing message by the user interface; and
a transceiver configured to send the outgoing message to a destination device corresponding to the information populated in the outgoing header field.

14. The messaging device of claim 11, wherein the existing header field is a source field retrieved from an incoming message box.

13. The messaging device of claim 11, wherein the existing header field is a destination field retrieved from an outgoing message box.

14. The messaging device of claim 11, wherein the outgoing message is one of a new message and an existing message.

15. The messaging device of claim 11, wherein the information of the outgoing header field is one of address information and identification information associated with the address information.

16. A messaging device for responding to multiple messages comprising:
a user interface configured to identify a first message including a first header field and to detect selection of a second message, including a second header field, from a message receptacle;
a processor configured to populate the first header field of the first message with information from the second header field of the second message in response to detecting selection of the second message by the user interface; and
a transceiver configured to send the second message to a destination device corresponding to the information populated in the second header field.

17. The messaging device of claim 16, wherein the second header field is a source field retrieved from an incoming message box.

18. The messaging device of claim 16, wherein the second header field is a destination field retrieved from an outgoing message box.

19. The messaging device of claim 16, wherein the first message is one of a new message and an existing message.

20. The messaging device of claim 16, wherein the information of the first header field is one of address information and identification information associated with the address information.
